(19) United States
(12) Patent Application Publication
(10) Pub. No.: US 2023/0059493 A1
(43) Pub. Date: Feb. 23, 2023

(54) Input/Output Assembly and Method for Increasing Fail Safe Operation of an Industrial Input/Output Assembly

(71) Applicant: Siemens Aktiengesellschaft, Muenchen (DE)

(72) Inventors: Sarah SCHMIDT, Chemnitz (DE); Rene KROEMER, Hohenstein-Ernstthal (DE)

(21) Appl. No.: 17/886,544

(22) Filed: Aug. 12, 2022

(30) Foreign Application Priority Data
Aug. 17, 2021 (EP) 21191703

(51) Int. Cl. G01P 15/08; G01P 1/12

(52) U.S. Cl. CPC G01P 15/0891; G01P 1/127

(57) ABSTRACT

A method for increasing fail-safe operation of an industrial input/output assembly, wherein an external mechanical load that acts on the input/output assembly is determined via an acceleration sensor, where a check is performed to determine whether the load exceeds a predeterminable limit value and, if this is the case, a value of a load sum is then accordingly increased corresponding to an extent to which the value is exceeded, where the load sum is continuously compared to a maximum load value that characterizes a service life of the input/output assembly, and a maintenance message is output when the maximum load value is reached.

### BACKGROUND OF THE INVENTION

### 1. Field of the Invention

The invention relates to a method for increasing fail-safe operation of an industrial input/output assembly, where an external mechanical load that acts on the input/output assembly is determined via an acceleration sensor, and where a check is performed to determine whether the load exceeds a predeterminable limit value and, if this is the case, then a value of a load sum is accordingly increased corresponding to the extent to which the value is exceeded.

The invention furthermore relates to an input/output assembly comprising an acceleration sensor, a measuring device that is configured to measure an external mechanical load via the acceleration sensor, and furthermore comprising a checking device that is configured to check whether the load has exceeded a predeterminable limit value.

### 2. Description of the Related Art

Industrial input/output assemblies are used in industrial automation, in particular as a decentralized peripheral, so as to control actuators and read sensors. Such assemblies or modules of the decentralized peripherals are associated, depending on the application field, with the protection classes IP20 or IP67. The assemblies of the IP67 protection class, for example of Siemens AG, are inter alia represented by the families ET 200eco PN, ET 200AL and ET 200eco PN M12-L. These assemblies can be assembled directly at the operation site without a switching cabinet, for example, on robotic arms or other machine parts. Assemblies of the protection class IP67 are particularly widespread for small local automation tasks (for example, door controls or robotic arm applications). These modules are often used under a particularly heavy mechanical load that exceeds the specified values. This can lead to early failures of the assemblies.

### SUMMARY OF THE INVENTION

It is an object of the present invention is to provide a method for increasing fail-safe operation of an input assembly/output assembly.

It is also an object of the invention to provide an input/output assembly that can be used with an increased fail-safe operation in particularly mechanically loaded environments.

These and other objects and advantages are achieved in accordance with the invention by method via which a check is performed to determine whether a load exceeds a predeterminable limit value and, if this is the case, then a value of a load sum is accordingly increased corresponding to the extent by which the value is exceeded, where the load sum is continuously compared to a maximum load value that characterizes a service life of an input/output assembly, and for the case that the maximum load value is reached, a maintenance message is output. If an input/output assembly on a rapidly moving robotic arm is intensely loaded in such a manner that its mechanical loads with regard to the acceleration, which act upon the input/output assembly, go beyond the vibration check according to International Electrotechnical Commission (IEC) standard 60068-2-6, then as a result of the method an imminent system failure for the input/output assembly is promptly identified and condition-based maintenance is avoided. Since industrial input/output assemblies are subjected to harsh vibration tests or shock tests, during the vibration test, for example, a constant acceleration of 20 G is performed having a vibration period of 10 frequency sweeps per axis in each of the three axes that are perpendicular with respect to one another. In the case of a shock load by means of a sinusoidal half wave, for example a shock of 30 G is applied for the duration of 18 μs. Also here in each case in each of the three axes that are perpendicular to one another the shock is recorded as a load during the test.

A further improvement of the method provides for recordation of a time continuous signal curve using the acceleration sensor and calculation of the load sum with the aid of an integration.

In accordance with the method, it is furthermore provided to statistically evaluate the measured values for the mechanical load. After these measure values have been read out, the measured values that the acceleration sensor provides are statistically evaluated, for example, by averaging, in order to obtain information from the environment of the input/output assembly.

The method is yet further improved if a mass of the input/output assembly is taken into consideration for the calculation of the load sum. The loads in general are provided on account of accelerations and, in this case, dead weight of the input/output assembly is of crucial importance. Consequently, the forces relating to the dead weight of the assembly can be taken into consideration.

It is also advantageous if a temperature of the input/output assembly is taken into consideration for the calculation of the load sum. The reason for this is that an input/output assembly, in the case of extreme temperatures, is additionally subjected to tremors and vibrations and small cracks can therefore occur between circuit boards and components that are attached thereto, and the cracks can in turn lead to the failure of the complete electronics assembly. A failure prediction probability is therefore improved by taking the temperature into consideration.

It is also possible to determine a maximum load value by experimental vibration and shock testing. This would then be a determination of a vibration test, this equates then to a vibration test that extends far beyond the requirements according to the IEC 60068-2-6 and IEC 60068-2-27 standards because, in the case of this experimental determination, the assembly would only be shocked until it actually fails. This then equates to an actual failure limit that is determined by experimental vibration and shock testing and the value for the actual failure limit is used in the input/output assembly for the output of an alarm notification.

In summary, in accordance with the method it can be said that the mechanical loads of an input/output assembly can be determined and it is possible to derive the statements regarding a mechanical aging of the input/output assembly. With this information, it is possible to realize monitoring and maintenance alarms having configurable threshold values.

If the measured values in addition are provided with time stamps, statements regarding the past development of the machine movement are possible. In this case, limit loads are identified by a statistical processing of the measured data. Statements regarding a path that is covered are possible by a differentiation of the acceleration measured values while it is possible to evaluate a mechanical load over the time by an integration of the measured values. In particular, from the integration of the measured values, it is possible to derive statements regarding the load on contacts, soldering sites, press-fit connections and similar during the lifecycle of the input/output assembly. The consideration of the inner temperature of the input/output assembly also plays a fundamental role, here. A maximum use time of the input/output assembly can be determined therefrom in a process dependent manner.

This information is useful for customers in order to be able to utilize a full lifespan of the input/output assembly that is dependent upon the use conditions. This leads to a sustainable handling of resources because it is not necessary to prematurely exchange any input/output assemblies that have been loaded to a lesser degree and accordingly last longer.

The previously mentioned objects in accordance with the invention are likewise achieved by an input/output assembly comprising an acceleration sensor, a measuring device that is configured to measure an external mechanical load via the acceleration sensor, a checking device that is configured to check whether the load has exceeded a predeterminable limit value, a load sum counter that is configured to add to a load sum an extent by which the predeterminable limit is exceeded, a monitoring device that is configured to continuously compare the load sum to a maximum load value that characterizes a service life of the input/output assembly, where a maintenance message is output when the maximum load value is reached.

An input/output assembly that promptly identifies an imminent system failure is now advantageously provided. A quality of such an input/output assembly is now enormously increased because necessary maintenance and intense aging can be identified at an early stage. As a consequence, it is possible to avoid failures in the automation system of the customer and this leads to fewer failures of the production process.

The input/output assembly furthermore has a recording device that is connected to the acceleration sensor and that records a time continuous signal curve, where an integration device is provided that is configured to calculate the load sum with the aid of an integration via the signal curve.

In a further improvement of the input/output assembly, this has a processing module that continuously converts the values via an analog-digital converter and performs a vibration analysis after a transformation in the frequency range and statistically evaluates the measured values for the mechanical load.

After they have been read out, the measured values that the acceleration sensor provides in the input/output assembly are statistically evaluated, for example, by averaging, in order to obtain information from the environment of the module.

In order to precisely determine in particular a mechanical aging, a parameterizable memory is provided in the assembly and the mass of the input/output assembly can be input into the memory and the mass can be retrieved for the calculation of the load sum. Particularly in the case of moving masses, the dead weight of the assembly plays a crucial role for the mechanical load.

A temperature that the assembly is subjected to likewise plays a further crucial role for a mechanical aging. For this reason, the input/output assembly has a temperature sensor, where a temperature of the input/output assembly can be retrieved for the calculation of the load sum.

Furthermore, the input/output assembly has further parameterizable memories in which a maximum load value that is determined in an experimental manner or an actual failure limit can be input into the further parameterizable memories.

In a preferred embodiment, the acceleration sensor is formed as a Micro Electro-Mechanical System (MEMS) sensor.

A further customer benefit is the output of the preprocessed measured values via a fieldbus system with the result that the customer can further use and process these measured values. For this purpose, the input/output assembly has a fieldbus interface and a transmitting device, where it is possible via the transmitting device to transmit all the measured values and maintenance messages via the fieldbus interface to a fieldbus.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

An exemplary embodiment of a telescopic strut in accordance with the invention will be explained hereunder by way of the drawings, in which:

FIG. 1 shows an exemplary embodiment of an input/output assembly in accordance with the invention; and

FIG. 2 is a flowchart of the method in accordance with the invention.

### DETAILED DESCRIPTION OF THE EXEMPLARY EMBODIMENTS

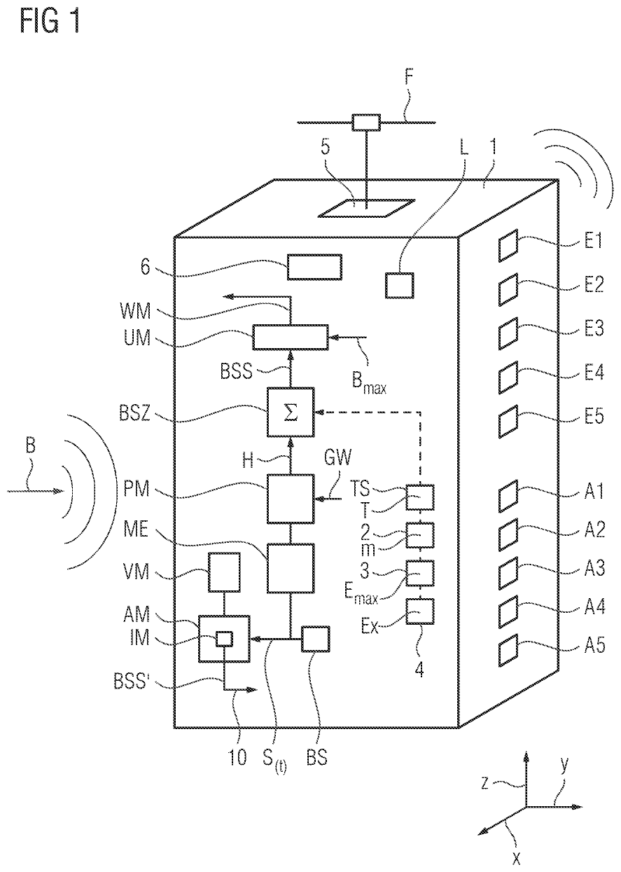

With reference to FIG. 1, illustrated therein is an input/output assembly 1 comprising an acceleration sensor BS, a measuring device ME and a checking device PM. The measuring device ME receives measured values from the acceleration sensor BS and checks the measured values for whether these values exceed a predeterminable limit value GW. For each occasion the predeterminable limit value GW is exceeded, an extent H by which the limit value is exceeded is summed in the load sum counter BSZ. In order to monitor these summed loads, in turn a monitoring device UM is provided that is configured to continuously compare the load sum BSS to a maximum load value B_{Max} that characterizes a service life L of the input/output assembly 1 and for the case that the maximum load value B_{Max} is reached, a maintenance message WM is output.

Furthermore, the input/output assembly 1 has a recording device AM that is connected to the acceleration sensor BS and records a continuous signal curve S(t), where an integration device IM is provided that is configured to calculate the load sum BSS′ with the aid of an integration via the signal curve S(t).

A processing module VM is configured to convert time continuous values via an analog-digital converter and to perform a vibration analysis after a transformation in the frequency range, such as the Fast Fourier transformation, and to statistically evaluate the measured values for the mechanical load B.

With regard to a yet more precise statement regarding a possible future point in time of failure, the input/output assembly 1 has parameterizable memories 2,3,4. A mass m of the input/output assembly 1 can be stored in a first memory 2. A maximum load value E_{Max} that is determined in an experimental manner can be stored in a second memory 3 or can be externally parameterized. A failure limit Ex can be parameterized in a third memory 4.

The stored values such as mass m, load value E_{Max} that is determined in an experimental manner and failure limit Ex can be included in the calculation regarding a future point in time of failure.

In addition thereto, a temperature sensor TS provides the temperature T prevailing at the time in the input/output assembly 1. If, in addition to a mechanical load B, the temperature T of the assembly is also still particularly high, a mechanical aging that is caused by a mechanical load B thus increases yet further and the assembly could fail more rapidly.

In order to be able to also relay the detected measured values to a superordinate automation system, the input/output assembly 1 has a fieldbus interface 5 and a transmitting device 6, where all the measured values and maintenance messages WM can be transmitted via the transmitting device 6 via the fieldbus interface 5 to a fieldbus 7.

The mechanical loads B that act on the input/output assembly 1 are typically provided in an x,y,z coordinate system on three axes. For receiving decentralized process values, the assembly has a first input E1 up to a fifth input E5. For the output of actuator values for the industrial process, the assembly has a first output A1 up to a fifth output A5.

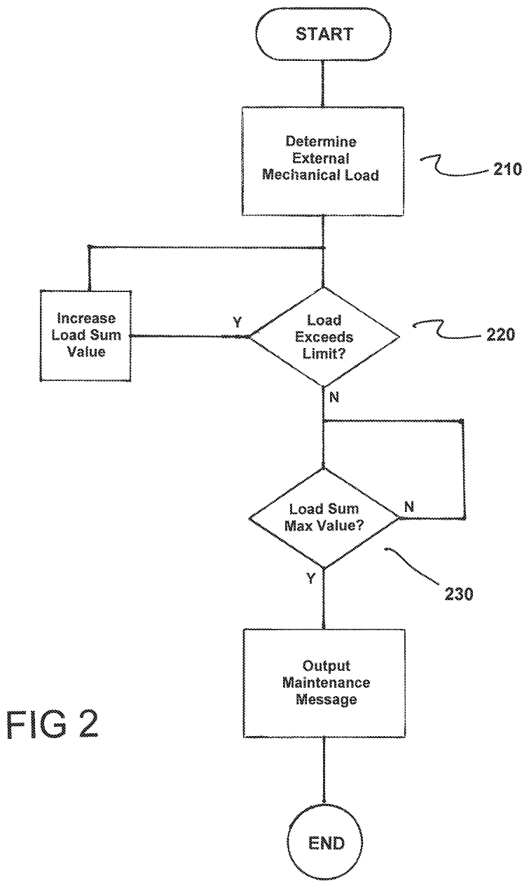

FIG. 2 is a flowchart of the method for increasing fail-safe operation of an industrial input/output assembly 1. The method comprises determining an external mechanical load B that acts on the input/output assembly 1 via an acceleration sensor BS, as indicated in step 210.

Next, a check is performed to determine whether the load B exceeds a predeterminable limit value GW and increasing a value of a load sum BSS is increased corresponding to an extent H to which the value is exceeded if the load B exceeds the predeterminable limit value GW, as indicated in step 220.

Next, the load sum BSS is continuously compared to a maximum load value B_{Max} which characterizes a service life L of the input/output assembly 1, as indicated in step 230. In accordance with the invention, a maintenance message WM is output when the maximum load value B_{Max} is reached.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for increasing fail-safe operation of an industrial input/output assembly, the method comprising:
determining an external mechanical load that acts on the input/output assembly via an acceleration sensor;
performing a check to determine whether the load exceeds a predeterminable limit value and increasing a value of a load sum corresponding to an extent to which the value is exceeded if the load exceeds the predeterminable limit value;
comparing the load sum continuously to a maximum load value which characterizes a service life of the input/output assembly and outputting a maintenance message when the maximum load value is reached.

2. The method as claimed in claim 1, wherein a time continuous signal curve is recorded using the acceleration sensor and the load sum is calculated aided by an integration.

3. The method as claimed in claim 1, wherein the measured values for the mechanical load are statistically evaluated.

4. The method as claimed in claim 2, wherein the measured values for the mechanical load are statistically evaluated.

5. The method as claimed in claim 1, wherein a mass of the input/output assembly is taken into consideration during calculation of the load sum.

6. The method as claimed in claim 1, wherein a temperature of the input/output assembly is taken into consideration during calculation of the load sum.

7. The method as claimed in claim 1, wherein the maximum load value is determined by experimental vibration and shock testing.

8. The method as claimed in claim 1, wherein an actual failure limit is determined by experimental vibration and shock testing and a value for an actual failure limit is utilized in the input/output assembly for output of an alarm notification.

9. An input/output assembly comprising:
an acceleration sensor;
a measuring device configured to measure an external mechanical load via the acceleration sensor;
a checking device configured to check whether the load has exceeded a predeterminable limit value;
a load sum counter configured to add to a load sum an extent to which the predeterminable limit is exceeded;
a monitoring device configured to continuously compare the load sum to a maximum load value which characterizes a service life of the input/output assembly, and configured to output a maintenance message when the maximum load value is reached.

10. The input/output assembly as claimed in claim 9, further comprising:
a recording device which is connected to the acceleration sensor and which records a time continuous signal curve; and
an integration device configured to calculate the load sum aided by an integration via the signal curve.

11. The input/output assembly as claimed in claim 9, further comprising:
a processing module which converts time continuous values via an analog-digital converter and which performs a vibration analysis after a transformation in a frequency range and which statistically evaluates measured values for the mechanical load (B).

12. The input/output assembly as claimed in claim 10, further comprising:
a processing module which converts time continuous values via an analog-digital converter and which performs a vibration analysis after a transformation in a frequency range and which statistically evaluates measured values for the mechanical load.

13. The input/output assembly as claimed in claim 9, further comprising:
a parameterizable memory;
wherein the mass of the input/output assembly is input into said parameterizable memory, the mass being retrievable from said parameterizable memory for calculation of the load sum.

14. The input/output assembly as claimed in claim 10, further comprising:
a parameterizable memory;
wherein the mass of the input/output assembly is input into said parameterizable memory, the mass being retrievable from said parameterizable memory for calculation of the load sum.

15. The input/output assembly as claimed in claim 11, further comprising:
a parameterizable memory;
wherein the mass of the input/output assembly is input into said parameterizable memory, the mass being retrievable from said parameterizable memory for calculation of the load sum.

16. The input/output assembly as claimed in claim 9, further comprising:
a temperature sensor;
wherein a temperature of the input/output assembly is retrievable for calculation of the load sum.

17. The input/output assembly as claimed in claim 9, further comprising:
further parameterizable memories in which a maximum load value which is determined in an experimental manner or an actual failure limit is input into said further parameterizable memories.

18. The input/output assembly of claim 9, wherein the acceleration sensor comprises a MEMS sensor.

19. The input/output assembly of claim 9, further comprising:
a fieldbus interface; and
a transmitting device;
wherein all measured values and maintenance messages are transmittable via the transmitting device via the fieldbus interface to a fieldbus.
